(19) United States
(12) Patent Application Publication
(10) Pub. No.: US 2009/0025264 A1
(43) Pub. Date: Jan. 29, 2009

(54) LIGHT-EMITTING SIGN DEVICE

(76) Inventors: Sueyoshi Daimon, Tokyo (JP); Tsunehide Naruse, Mito-shi (JP); Yukiharu Suzuki, Tokyo (JP)

Correspondence Address: Joseph W. Price;SNELL & WILMER, L.L.P, 600 Anton Boulevard, Suite 1400, Costa Messa, CA, 92626, US

(21) Appl. No.: 12/177,784

(22) Filed: Jul. 22, 2008

(30) Foreign Application Priority Data
Jul. 27, 2007 (JP) 2007-196058

(51) Int. Cl. G09F 13/18

(52) U.S. Cl. 40/546

(57) ABSTRACT

A light-emitting sign device is provided, in which optimum scattering of light from a light source is ensured, light loss can be reduced to a minimum, uniform and bright emission is made possible, and visibility and cost efficiency are improved. A sign plate having a sign surface is provided, and a light-diffusing plate, light guide plate, and white reflecting plate are arranged in this order on the rear surface of the sign plate. A light-scattering layer that scatters the light from the light source is coated on the rear surface of the light guide plate. The light-scattering layer has a binder layer composed of a coating composition using a transparent resin as a binder. A filler in the form of transparent and substantially spherical fine particles of silica is uniformly dispersed in the binder layer.

### BACKGROUND OF THE INVENTION

1. Field of the Invention

The present invention relates to a light-emitting sign device of an edge light type in which surface emission from a sign member is performed, and more particularly to a light-emitting sign device improved so as to ensure uniform light emission from a sign member.

2. Description of the Related Art

Sign members such as marks or signboards for stores or advertisement are required to demonstrate high visibility so that they can be readily recognized even at night. For this purpose, there are sign device that illuminate the sign members with a projector from the front surface and light-emitting sign devices in which a light source is mounted on the rear surface of the sign member to cause surface emission from the sign member. Among these devices, in the light-emitting sign devices of an edge light type, a light source is provided close to the side edge portion of the sign member, and since the light source is provided at the side of the sign member, the device can be reduced in thickness and more downsized.

Therefore, the light-emitting sign devices of an edge light type excel in cost efficiency and convenience, but since the light of the light source is incident on the sign surface of the sign member from the side thereof, light emission is uneven. In other words, in the light-emitting sign devices of an edge light type, it is difficult to obtain a uniform incident light on the sign surface from the light of the light source provided on the side of the sign member. As a result, the occurring emission unevenness degrades visibility.

A trend toward creating sign members of increased size has been observed in recent years, and large sign members with a sign surface of about 1 m×2 m have been appeared on the market. Therefore, it is an essential condition to provide light emission of uniform intensity and prevent emission unevenness, and it is important to ensure uniform surface emission from the entire large sign surface. Various techniques have been suggested to meet this need. For example, a technique described in Japanese Patent Application Laid-open No. 2005-31596 is known.

In the technique described in Japanese Patent Application Laid-open No. 2005-31596, there is a characteristic that a film serving as a sign member is covered from the back surface with a transparent plate, and a matte scattering portion is formed on the surface of the transparent plate that is in contact with the film. The uniformity of emission is attempted by scattering the light from the light source with the scattering portion.

However, the conventional light-emitting sign devices have been shown to have the following problems. Namely, in the technique described in Japanese Patent Application Laid-open No. 2005-31596, with the light guided from a transparent plate, not only the sign surface that is the film surface, but also the surface opposite the film rear surface, are illuminated. As a result, the light cannot be efficiently collected on the sign surface and the quality of light decreases, and then the scattering portion formed on the sign surface, which should have the light go out to the outer side of the sign surface, far from doing so, confines the light inside the sign member. As a result, sufficient brightness cannot be obtained and visibility is decreased. Therefore, light source output had to be increased to maintain visibility, thereby increasing cost.

As described above, in the field of light-emitting sign devices, it is necessary to emit light uniformly and evenly from the entire sign member and at the same time ensure a high brightness. Moreover, a product sufficiently suitable for industrial applications has to be developed without increasing the cost. In particular, in the field of light-emitting sign devices of an edge light type in which a light source is on the side, the light intensity is easy to become uneven and the brightness is easy to decrease with the increase in the size of the sign member. Therefore, it is an urgent task to ensure sufficient quantity of light, while ensuring appropriate scattering of light from the light source.

### SUMMARY OF THE INVENTION

With the foregoing in view, it is an object of the present invention to provide a light-emitting sign device in which optimum scattering of light from a light source is ensured, light loss can be reduced to a minimum, uniform and bright emission is made possible, and visibility and cost efficiency are improved.

In order to attain the above-described object, the present invention provides a light-emitting sign device, which has a sign member having a sign surface, and in which a light guide member is provided on a rear surface of the sign member, a light source is provided in the vicinity of a side edge portion of the light guide member, light of the light source is introduced from the side edge portion of the light guide member and the sign member is caused to emit light, the device having the following structural features. Namely, in accordance with the present invention, the device comprises: a light-scattering layer that scatters the light from the light source which is formed by coating on the rear surface of the light guide member; and a reflecting member that is provided opposite the light-scattering layer so as to sandwich the light-scattering layer between the reflecting member and the light guide member.

In accordance with the invention having the above-described features, the light guide member transmits the light from the light source to every corner of the light guide member. In this case, since the light-scattering layer is formed between the reflecting member and light guide member, the light of the light source that is incident on the light guide member is scattered by the light-scattering layer in the direction ensuring light uniformity on the reflecting member, and this light is reflected by the reflecting member toward the light-scattering layer. Therefore, the light is repeatedly scattered and reflected between the light-scattering layer and reflecting member and then taken out from the light guide member. For this reason, the light emitted from the light guide member has uniform intensity, no light loss, and no decrease in intensity. As a result, the sign member can be efficiently illuminated with the light from the light guide member, and this causes the sign member to emit uniform and bright light.

With the light-emitting sign device in accordance with the present invention, by using a very simple feature of a light-scattering layer formed between a reflecting member and a light guide member, it is possible to reduce light loss to a minimum, while ensuring optimum scattering of light from a light source, enable uniform and bright emission, and improve visibility and cost efficiency.

### BRIEF DESCRIPTION OF THE DRAWINGS

FIG. 1 is a perspective view of the typical embodiment of the present invention.

### DESCRIPTION OF THE PREFERRED EMBODIMENTS

### [Typical Configuration of Embodiment]

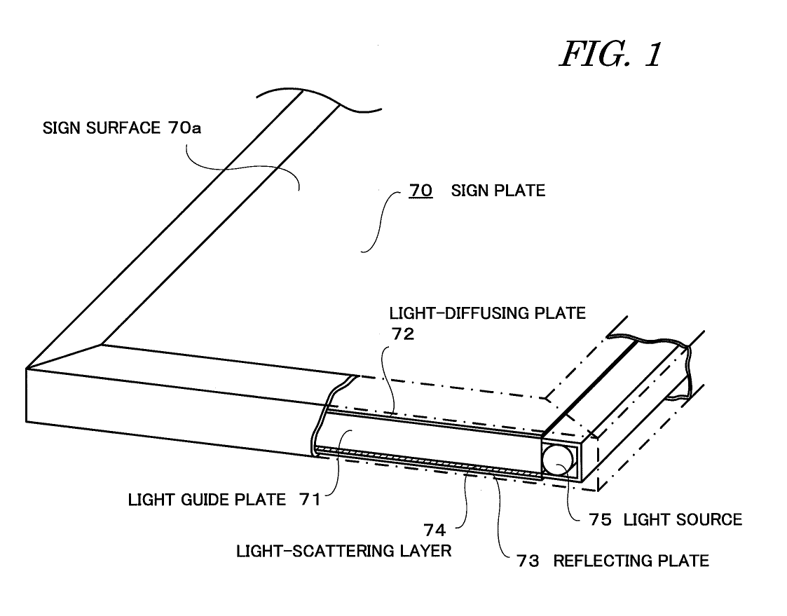

The best modes for carrying out the invention (referred to hereinbelow as “embodiments”) will be described below in detail with reference to the appended drawings. FIG. 1 is a perspective view illustrating the configuration of the present embodiment.

As shown in FIG. 1, the light-emitting sign device of the present embodiment is a light-emitting sign device of an edge light type in which a light source 75 is provided close to both side edge portions on short sides of a rectangular sign plate 70 having long sides and the short sides, wherein the sign plate 70 having a sign surface 70a is provided, and a light-diffusing plate 72, a light guide plate 71, and a white reflecting plate 73 are arranged in this order on the rear side of the sign plate. A specific feature of the present embodiment is that a light-scattering layer 74 that scatters light from the light source 75 is formed by coating on the rear surface of the light guide plate 71 so that the light-scattering layer 74 is sandwiched between the white reflecting plate 73 and light guide plate 71. An elongated LED light source is used as the light source 75.

The light-scattering layer 74 has a binder layer composed of a coating material composition containing a transparent resin as a binder and is formed by uniformly dispersing transparent and almost spherical silica fine particles as a filler in the binder layer. More specifically, the light-scattering layer is prepared by mixing 50 parts by weight of an acrylic resin, 47 parts by weight of an organic solvent, and 3 parts by weight of a filler. Further, the coating thickness of the light-scattering layer 74 is 5 to 20 μm in a dry state. Here, the actual coating thickness is appropriately adjusted according to the size of the light guide plate 71 and brightness required for the sign plate 70.

A mixture of an alcohol, a ketone, an ester, toluene, and the like is used as the organic solvent, and the ratio of components in the mixture is adjusted according to the solubility, volatility, and leveling characteristic of the binder resin. The mean particle size of the filler is 1 to 10 μm.

### [Action and Effect of the Typical Embodiment]

The present embodiment having the above-described features demonstrates the following action and effect. Namely, since the light-scattering layer 74 is coated on the rear surface of the light guide plate 71, the light of the light source 75 incident on the light guide plate 71 is scattered to improve uniformity toward the white reflecting plate 73 by the filler dispersed in the light-scattering layer 74. Based on the concept of a typical matte coating material, the amount of filler (3 parts by weight) in the light-scattering layer 74 is very small. Therefore, the light loss that is due to scattering can be minimized.

The white reflecting plate 73 reflects the light received from the light-scattering layer 74 toward the light-scattering layer 74. Thus, the light is repeatedly scattered and reflected between the light-scattering layer 74 and white reflecting plate 73, whereby light uniformity can be improved, while inhibiting light loss. As a result, uniform light of high intensity can be taken out from the front surface of the light guide plate 71. The light taken out from the front surface of the light guide plate 71 is diffused by passing through the light-diffusing plate 72, thereby making it possible to obtain uniform and bright emission from the sign plate 70.

In a comparative example relating to the present embodiment, a light-emitting sign device was produced that differed from the device of the present invention only as to whether a light-scattering layer 74 was formed on the rear surface of a light guide plate 71. In the comparative example, a sign surface 70a of a sign plate 70 was bright in the central zone and dark on the circumference, and uniform surface emission could not be obtained over the entire body. This is apparently since the scattering with the light-scattering layer 74 of the light reflected by a white reflecting plate 73 was not sufficiently uniform and, therefore, bright zone was obtained only in the center of the sign surface 70a.

With the above-described embodiment, a very simple feature of forming the light-scattering layer 74 between the white reflecting plate 73 and light guide plate 71 makes it possible to optimize the scattering of light of the light source 75 and minimize the light loss at the same time. Therefore, uniform and bright surface emission of the sign plate 70 can be realized even in a light-emitting sign device of an edge light type and, therefore, visibility can be improved. Further, it is not necessary to increase the output of the light source 75 in order to increase the brightness. Therefore, cost increase can be avoided. As a result, a light-emitting sign device of sufficient industrial applicability and cost efficiency can be provided.

### Another Embodiment

The present invention is not limited to the above-described embodiments, and the configuration, materials, shape, and dimensions of components can be changed appropriately. More specifically, the sign member, light-scattering member, light guide member, and white reflecting member may be not only in the form of plates, but also in the form of sheets or films, and the appropriate thickness of the light-scattering layer can be selected.

Concerning the thickness of the light-scattering layer, when the light-scattering layer is thin, a intense beam is outputted, but the scattering characteristic of light is decreased and the light cannot be sufficiently diffused. As a result emission unevenness readily occurs. Conversely, when the light-scattering layer is thick, light scattering characteristic is sufficient and, therefore light emission unevenness hardly occurs, but the quantity of light decreases and brightness drops. Accordingly, the adequate light-scattering layer thickness is established according to the installation location or type of the light-emitting sign device with consideration for a balance of the scattering characteristic and quantity of light. When the light-scattering layer has a patterned shape such as a dot-like or grid-like shape, emission unevenness occurs. Therefore, it is preferred that the light-scattering layer be formed uniformly. This limitation is not imposed on configuration in which local emission is required correspondingly to the type of the sign member. In such cases, the shape of light-scattering layer can be adapted to the required emission.

As for examples of materials for the aforementioned members, the light-diffusing member serving as a light-diffusing plate may be composed of an acrylic resin, a polycarbonate resin, a polyester resin, a silicone resin, a polypropylene resin, glass, silica or alumina that has a diffusion agent filled inside or coated on the surface thereof.

The reflecting member may be composed of a polyester resin, a polycarbonate, or an acrylic resin that is filled with fine powder of titanium oxide or fine gas bubbles, or may be coated with a white coating material containing titanium oxide as the main component. As for the light sources, the LED of the above-described embodiments has a merit of small power consumption, but an incandescent lamp, a fluorescent lamp, a cathode ray tube, a super high-pressure mercury vapor lamp, and a halogen lamp can be also used.

The binder layer of the light-scattering layer is not limited to acrylic resins, and a mixture of nitrocellulose and an alkyd resin, a polycarbonate, a polyurethane resin, a polyester resin, an epoxy resin, and a silicone resin or a vinyl chloride resin can be also used. As for the filler of the light-scattering layer, an inorganic material such as silica, glass, alumina, and titanium oxide, or an organic material such as a polypropylene, a polyethylene, a polycarbonate, a polyester, an acrylic resin, and a silicone resin may be used.

The mixing ratio in the coating material composition of the light-scattering layer can be changed appropriately, provided that the result does not depart from the scope of the present invention. For example, the coating material composition may contain 50 parts by weight of a mixture of a nitrocellulose and alkyd resin, 46 parts by weight of an organic solvent, and 4 parts by weight of a filler.

The filler is a medium enabling the light-scattering layer to scatter light, and materials with good transparency and a high refractive index are preferred. The amount of the filler added to the light-scattering layer differs depending not only on material, but also on the filler diameter. For example, when the particle size is large, the amount of filler added can be decreased and uniformity during coating can be improved. Typically, when the amount of filler added is small, scattering characteristic is insufficient. Conversely, when the amount of filler added is large, the light is shielded and the quantity of light becomes insufficient. In other words, the variations in the amount of filler added demonstrate the same effect as those of the light-scattering layer thickness. Therefore, the adequate amount of filler is established according to the installation location or type of the light-emitting sign device with consideration for a balance of the scattering characteristic and quantity of light.

Further, with regard to the coating material composition of the light-scattering layer, a polyisocyanate compound may be mixed immediately prior to coating in an amount equivalent to 15% in relation to an acrylic resin, without using an alcohol-based solvent. Such light-scattering layer is sufficiently dried and allowed to stay for 10 hours in a furnace at 50° C. to cure the coating film. In this case, the hardness of the coating film is increased. More specifically, when the hardness of the coating film was measured by pencil hardness test, it increased from F to 3H. As a result, resistance to damage such as scratching has increased and also the Young's modulus of the coating film increased. In addition, curing also increased glass transition temperature. Therefore, weather resistance (moisture resistance and thermal resistance) is improved.

The sign member may be configured by a transparent member and a sign object sandwiched between the transparent member and light guide member, and the sign portion may be formed by engraving the transparent member or forming dots. The sign object may be of variety of kinds and shapes such as signboards, emergency lights, and road signs. Possible applications of the light-emitting sign device in accordance with the present invention are manifold, and specifically, include information signs for shops and advertisement and also for welfare vehicles, traffic facilities, public institution, etc.

What is claimed is:

1. A light-emitting sign device, which has a sign member having a sign surface, and in which a light guide member is provided on a rear surface of the sign member, a light source is provided in the vicinity of a side edge portion of the light guide member, light of the light source is introduced from the side edge portion of the light guide member and the sign member is caused to emit light, the device comprising:
a light-scattering layer that scatters the light from the light source, which is formed by coating on the rear surface of the light guide member; and
a reflecting member that is provided opposite the light-scattering layer so as to sandwich the light-scattering layer between the reflecting member and the light guide member.

2. The light-emitting sign device according to claim 1, wherein
the light-scattering layer is composed of:
a binder layer composed of an acrylic resin, a mixture of nitrocellulose and an alkyd resin, a polycarbonate, a polyurethane resin, a polyester resin, an epoxy resin, a silicone resin or a vinyl chloride resin; and
a filler in a form of fine powder composed of an inorganic material containing at least one from silica, glass, alumina, and titanium oxide, or an organic material containing at least one from a polypropylene, a polyethylene, a polycarbonate, a polyester, an acrylic resin, and a silicone resin, the filler being filled into the binder layer so as to be uniformly dispersed therein.

3. The light-emitting sign device according to claim 2, wherein the light-scattering layer contains 2.5 parts by weight to 4 parts by weight of the filler.

4. The light-emitting sign device according to claim 1, wherein the light-scattering layer has a thickness of 5 μm to 20 μm.

5. The light-emitting sign device according to claim 1, wherein at least one from among an incandescent lamp, a fluorescent lamp, a cathode ray tube, a super high-pressure mercury vapor lamp, a halogen lamp, and a LED is used as the light source.

6. The light-emitting sign device according to claim 1, wherein the reflecting member is composed of a polyester resin, a polycarbonate, or an acrylic resin with fine powder of titanium oxide or fine gas bubbles filled therein.

7. The light-emitting sign device according to claim 1, wherein the reflecting member is obtained by coating a white coating material containing titanium oxide as the main component.

8. The light-emitting sign device according to claim 1, wherein a light-diffusing member that diffuses light from the light source is provided between the light guide member and the sign member.

9. The light-emitting sign device according to claim 8, wherein the light-diffusing member is composed of an acrylic resin, a polycarbonate resin, a polyester resin, a silicone resin, a polypropylene resin, glass, silica or alumina that has a diffusion agent filled therein or coated on the surface thereof.

10. The light-emitting sign device according to claim 1, wherein the sign member is composed of a transparent member and a sign object sandwiched between the transparent member and the light guide member.

11. The light-emitting sign device according to claim 1, wherein the sign member is composed of a transparent member that has a sign portion formed thereon by engraving or dots.
